(19) United States
(12) Patent Application Publication
(10) Pub. No.: US 2010/0192724 A1
(43) Pub. Date: Aug. 5, 2010

(54) POWER TRANSMISSION DEVICE WITH INTERNAL ACTUATOR

(76) Inventor: Sankar Mohan, Jamesville, NY (US)

Correspondence Address: MAGNA INTERNATIONAL, INC., 337 MAGNA DRIVE, AURORA, ON, L4G-7K1, CA

(21) Appl. No.: 12/440,057

(22) PCT Filed: Aug. 22, 2007
(86) PCT No.: PCT/US07/18548

§ 371 Date: Mar. 5, 2009

Related U.S. Application Data
(60) Provisional application No. 60/842,929, filed on Sep. 7, 2006.

(51) Int. Cl. F16H 37/06; F16D 13/00; F16D 15/00; F16D 28/00

(52) U.S. Cl. 74/665 F; 192/82 R; 192/93 A; 192/84.1

(57) ABSTRACT

A power transmission device has a first shaft adapted to be driven by a power source. A second shaft is adapted to transmit torque to a driveline. A transfer unit is selectively operable to transmit torque between the first and second shafts. The transfer unit includes a first sprocket that is rotatably supported on one of the first and second shafts, a second sprocket that is fixed for rotation with the other of the first and second shafts, and a flexible member that drivingly interconnects the first and second sprocket. A clutch is selectively operable to drivingly interconnect the first sprocket and one of the first and second shafts such that drive torque is transferable from the first shaft to the second shaft. The clutch is controlled by a clutch actuation system having an actuator that is at least partially positioned within a volume defined by the flexible member.

### CROSS-REFERENCE TO RELATED APPLICATIONS

This application claims priority of U.S. Provisional Application No. 60/842,929, filed on Sep. 7, 2006 and claims the benefit of U.S. Provisional Application No. 60/834,673, filed on Jul. 31, 2006. The disclosure of the above application is incorporated herein by reference.

### FIELD

The present disclosure relates generally to power transmission devices for use in motor vehicles. More particularly, the present disclosure relates to shifting mechanisms for four-wheel drive vehicles.

### BACKGROUND

Many light-duty and sport-utility vehicles are equipped with a transfer case for transmitting drive torque to all four of the wheels, thereby establishing a four-wheel drive mode of operation. These transfer cases are equipped with a mode shift mechanism which permits the vehicle operator to selectively shift between a two-wheel drive mode wherein only the primary (i.e., rear) driveline is driven and a “part-time” four-wheel drive mode wherein the secondary (i.e., front) driveline is rigidly coupled for rotation with the primary driveline. To accommodate differing road surfaces and conditions, many transfer cases are also equipped with a gear reduction unit which can be selectively shifted to permit the vehicle operator to choose between a four-wheel high-range (i.e., direct ratio) drive mode and a four-wheel low-range (i.e., reduced ratio) drive mode. Reference may be made to commonly-owned U.S. Pat. No. 4,770,280 for disclosure of an exemplary part-time transfer case equipped with a gear reduction unit and a synchronized mode shift mechanism.

In many transfer cases, the power-operated actuator associated with the mode shift mechanism and/or the range shift mechanism is secured to an outer surface of the housing. For example, reference can be made to commonly-owned U.S. Pat. Nos. 7,101,304 and 7,033,300 for illustration of conventional external mounting arrangements for the power-operated shift actuator. To accommodate the service life requirements associated with the environmental and road conditions to which the externally-mounted shift actuator will be exposed underneath the vehicle, its housing design and durability requirements typically result in a heavy and expensive assembly. To eliminate the expense and underbody packaging space associated with such externally-mounted shift actuators, a need exists to develop internally-mounted alternatives. Accordingly, the present disclosure is directed to solving the problems associated with conventional externally-mounted shift actuators of the type used in power transmission devices installed on motor vehicles.

### SUMMARY OF THE INVENTION

In view of the above, the present disclosure illustrates and describes a power transmission device for use in a four-wheel drive vehicle having a power source and first and second drivelines. The power transmission device includes a transfer unit that is selectively operable to transmit torque between a first shaft and a second shaft. The transfer unit includes a first sprocket rotatably supported on one of the first and second shafts, a second sprocket fixed for rotation with the other of the first and second shafts, and a flexible member drivingly interconnecting the first and second sprocket. A clutch is selectively operable to drivingly interconnect the first sprocket and one of the first and second shafts such that drive torque is transmitted from the first shaft to the second shaft. The clutch is controlled by a clutch actuation system having a power-operated actuator that is at least partially positioned within a volume defined by the flexible member.

### BRIEF DESCRIPTION OF THE DRAWINGS

The disclosure will now be described, by way of example, with reference to the accompanying drawings in which:

FIG. 1 is a schematic illustrating the drivetrain of a motor vehicle equipped with a power transmission device of the present disclosure;

FIG. 2 is a schematic of a two-speed power transmission device according to the present disclosure; and

FIG. 3 is a cross-sectional view of an alternative power transmission device associated with the drivetrain shown in FIG. 1.

### DETAILED DESCRIPTION OF THE PREFERRED EMBODIMENTS

In general, the present disclosure relates to a clutch actuation system located within the housing of a power transmission device of the type used in motor vehicles. The clutch actuation system may operate a mode clutch associated with the output shafts of the power transmission device for selectively or automatically shifting between various two-wheel drive and four-wheel drive modes. As an alternative, the clutch actuation system may operate a range shift mechanism operably associated with a gearset for permitting shifting of the power transmission device between a low-range speed ratio and a high-range speed ratio.

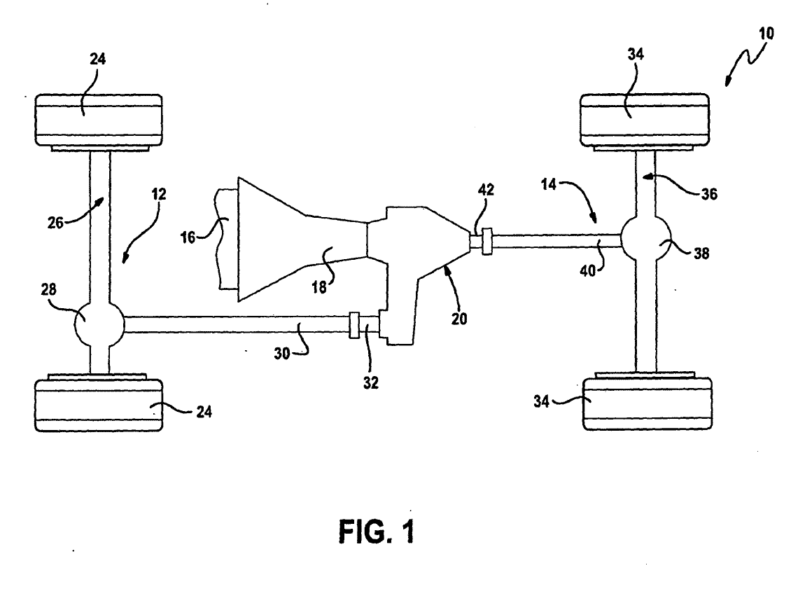

With particular reference to FIG. 1 of the drawings, a drivetrain 10 for a four-wheel drive vehicle is shown. Drivetrain 10 includes a front driveline 12 and a rear driveline 14 both drivable from a source of power, such as an engine 16, through a transmission 18 which may be of either the manual or automatic type. In the particular embodiment shown, drivetrain 10 is a four-wheel drive system which incorporates a power transmission device 20 for transmitting drive torque from engine 16 and transmission 18 to front driveline 12 and rear driveline 14. Front driveline 12 is shown to include a pair of front wheels 24 connected at opposite ends of a front axle assembly 26 having a front differential 28 that is coupled to one end of a front propshaft 30, the opposite end of which is coupled to a front output shaft 32 of power transmission device 20. Similarly, rear driveline 14 includes a pair of rear wheels 34 connected at opposite ends of a rear axle assembly 36 having a rear differential 38 coupled to one end of a rear propshaft 40, the opposite end of which is interconnected to a rear output shaft 42 of power transmission device 20.

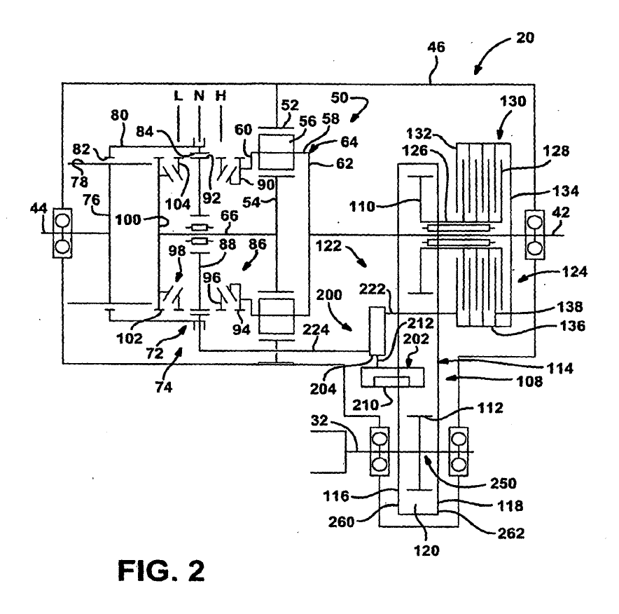

With particular reference to FIG. 2 of the drawings, power transmission device 20 is schematically shown to include an input shaft 44 which is rotatably supported in a housing 46. Input shaft 44 is adapted for connection to an output shaft (not shown) of transmission 18 such that both are rotatably driven by engine 16 of the motor vehicle. Likewise, front output shaft 32 and rear output shaft 42 are rotatably supported in housing 46. Power transmission device 20 is also shown to include a planetary gear assembly 50 which is operably installed between input shaft 44 and rear output shaft 42. Planetary gear assembly 50 includes a ring gear 52 fixed to housing 46, a sun gear 54, and a set of first pinion gears 56 which are each rotatably supported on a pinion shaft 58 and meshed with sun gear 54 and ring gear 52. Each pinion shaft 58 extends between a front carrier ring 60 and a rear carrier ring 62 which are interconnected to define a carrier assembly 64. Sun gear 54 is fixed to a quill shaft 66. As shown, rear carrier ring 62 is fixed to rear output shaft 42 such that driven rotation of carrier assembly 64 causes concurrent rotation of rear output shaft 42.

Planetary gear assembly 50 functions as a two-speed gear reduction unit which, in conjunction with a range clutch 72 of a synchronized range shift mechanism 74, is operable to establish a first or high-range speed ratio drive connection between input shaft 44 and carrier assembly 64 by directly coupling input shaft 44 to front carrier ring 60 of carrier assembly 64. Likewise, a second or low-range speed ratio drive connection is established by range clutch 72 between input shaft 44 and carrier assembly 64 by coupling input shaft 44 to sun gear 54. A neutral mode is established when input shaft 44 is uncoupled from both carrier assembly 64 and sun gear 54.

To provide means for selectively establishing the high-range and low-range drive connections between input shaft 44 and carrier assembly 64, synchronized range shift mechanism 74 is provided. Synchronized range shift mechanism 74 is operable for permitting power transmission device 20 to be shifted between its high-range and low-range drive modes while the vehicle is moving. As also noted previously, synchronized range shift mechanism 74 includes range clutch 72 which is operable for selectively coupling input shaft 44 to either of carrier assembly 64 or sun gear 54. In particular, range clutch 72 includes a drive gear or drive hub 76 that is fixed to input shaft 44. Drive hub 76 has an outer cylindrical rim on which external gear teeth or longitudinal splines 78 are formed. Range clutch 72 further includes a range sleeve 80 having a first set of internal splines 82 that are in constant mesh with external splines 78 on drive hub 76. Thus, range sleeve 80 is mounted for rotation with drive hub 76 and for axial sliding movement on drive hub 76 such that driven rotation of input shaft 44 causes concurrent rotation of range sleeve 80. Range sleeve 80 is shown to also include a second set of internal splines 84 which are offset axially from the first set of internal splines 82.

Range clutch 72 also includes a first synchronizer assembly 86 operably located between a neutral hub 88 rotatably supported on quill shaft 66 and a first clutch plate 90 which is fixed to front carrier ring 60 of carrier assembly 64. Neutral hub 88 has teeth 92 formed thereon while first clutch plate 90 has external clutch teeth 94 formed thereon. First synchronizer assembly 86 is operable for causing speed synchronization between input shaft 44 and carrier assembly 64 in response to movement of range sleeve 80 from a neutral position (denoted by position line “N”) toward a high-range position (denoted by position line “H”). Once the speed synchronization process is completed, range sleeve 80 is permitted to move through the teeth of a blocker ring 96 and into coupled engagement with first clutch plate 90 such that its splines 84 meshingly engage clutch teeth 94 on first clutch plate 90. Accordingly, with range sleeve 80 located in its H position, drive hub 76 is drivingly coupled to first clutch plate 90 such that carrier assembly 64 is coupled to rotate at the same speed as input shaft 44 for establishing the high-range drive connection.

Range clutch 72 further includes a second synchronizer assembly 98 operably disposed between neutral hub 88 and a second clutch plate 100 which is fixed to quill shaft 66 and has external clutch teeth 102 formed thereon. Second synchronizer assembly 98 is operable for causing speed synchronization between sun gear 54 and input shaft 44 in response to movement of range sleeve 80 from its N position toward a low-range position (denoted by position line “L”). Once speed synchronization is complete, range sleeve 80 is permitted to move through the teeth of a second blocker ring 104 and into coupled engagement with second clutch plate 100 such that its splines 84 meshingly engage clutch teeth 102 on second clutch plate 100 for establishing the low-range drive connection therebetween. With range sleeve 80 located in its L position, sun gear 54 drives pinion gears 56 about stationary ring gear 52 such that carrier assembly 64 is driven at a reduced speed ratio relative to input shaft 44, thereby establishing the low-range drive connection. While only schematically shown, first synchronizer assembly 86 and second synchronizer assembly 98 can be any conventional construction such as, for example, single-cone or dual-cone arrangements. Thus, it will be appreciated by those skilled in the art that any type of suitable synchronizer arrangement can be used for facilitating speed synchronization between the components that are to be directly coupled. In addition, it is to be understood that non-synchronized versions of the range shift system can also be used as well as alternative gearset arrangements providing the two-speed output feature.

Range sleeve 80 is shown in its neutral position (denoted by position line “N”) where its splines 84 are released from engagement with clutch teeth 94 on first clutch plate 90 and clutch teeth 102 on second clutch plate 100 and yet are engaged with teeth 92 on neutral hub 88. As such, driven rotation of input shaft 44 causes rotation of range sleeve 80 and neutral hub 88 which, as noted, is rotatably supported on quill shaft 66. Since range sleeve 80 does not couple input shaft 44 to either of clutch plates 90 and 100 when it is in its N position, no drive torque is transferred through carrier assembly 64 to front or rear output shafts 32 and 42, respectively, thereby establishing the neutral non-driven mode. Thus, internal splines 82 on range sleeve 80 maintain engagement with external splines 78 on drive hub 76 throughout the entire length of axial travel of range sleeve 80 between its H and L positions. Moreover, internal splines 82 do not engage clutch teeth 102 on second clutch plate 100 when range sleeve 80 is in its H position.

As seen, a transfer assembly 108 is provided for selectively transferring drive torque from rear output shaft 42 to front output shaft 32. Transfer assembly 108 includes a first or drive sprocket 110 rotatably supported on rear output shaft 42, a second or driven sprocket 112 fixed to front output shaft 32, and a continuous flexible member 114, such as a power chain, interconnecting driven sprocket 112 to drive sprocket 110. Flexible member 114 includes a first edge 116, a second edge 118 and a surface 120 extending from first edge 116 to second edge 118.

To provide means for establishing a drive connection between rear output shaft 42 and front output shaft 32, power transmission device 20 includes a mode shift mechanism 122. Mode shift mechanism 122 includes a mode clutch 124 which is operable to couple drive sprocket 110 to rear output shaft 42 for establishing a four-wheel drive mode wherein front output shaft 32 is coupled for rotation with rear output shaft 42. In addition, mode clutch 124 is operable for selectively uncoupling drive sprocket 110 from rear output shaft 42 for establishing a two-wheel drive mode wherein all drive torque is delivered to rear output shaft 42.

According to the embodiment shown in FIG. 2, mode clutch 124 is normally operable in a non-actuated mode for transmitting all drive torque to rear output shaft 42, thereby establishing the two-wheel drive mode. Mode clutch 124 is also operable in a fully-actuated mode for establishing a “locked” four-wheel drive mode in which front output shaft 32 is rigidly coupled to rear output shaft 42. In the embodiment shown in FIG. 2, mode clutch 124 is a friction plate clutch. Mode clutch 124 may be controlled to progressively regulate the amount of torque transferred to front output shaft 32 automatically (i.e., on-demand) between its non-actuated and fully-actuated modes in response to and as a function of the amount of relative rotation (i.e., interaxle slip) between front output shaft 32 and rear output shaft 42. The torque versus slip characteristics of mode clutch 124 can be tuned to meet specific vehicular applications.

Mode clutch 124 includes an inner hub 126 fixed to drive sprocket 110 and to which a set of inner clutch plates 128 are fixed. Mode clutch 124 also includes a drum assembly 130 comprised of an end plate 134 and a drum 136 to which end plate 134 is secured. Drum 136 is cylindrical and has a set of outer clutch plates 138 fixed thereto which are alternately interleaved with inner clutch plates 128 to define a multi-plate clutch pack. An apply plate 132 is driven by drum 136 and is axially moveable relative to the clutch pack. Other physical arrangements which perform the same function as mode clutch 124 are contemplated as being within the scope of the present disclosure.

A clutch actuation system 200 controls actuation of both range clutch 72 and mode clutch 124. Clutch actuation system 200 is schematically shown to include an actuator 202 a rotary to linear movement conversion mechanism 204. In particular, actuator 202 includes a drive motor 210 that is operable for rotating a drive shaft 212. Drive shaft 212 is coupled to a rotary input member of rotary to linear movement conversion mechanism 204. Conversion mechanism 204 converts rotary motion into linear movement of a first actuating arm 222 and a second actuating arm 224. Drive motor 210 may be electrically or hydraulically powered. Alternatively, actuator 202 need not be configured to include a drive motor but may utilize other force transmitting mechanisms as appropriate. Actuator 202 is shown to be at least partially located within a volume 250 defined by surface 120 of continuous flexile member 114, a first plane 260 defined by first edge 116 and a second plane 262 defined by second edge 118.

Furthermore, to provide means for establishing a clutch engagement force on mode clutch 124, actuator 202 is selectively controllable to move apply plate 132 for frictionally engaging inner clutch plates 128 with outer clutch plates 138, thereby transferring drive torque from rear output shaft 42 to front output shaft 32. Actuator 202 is also selectively operable to cease applying force on apply plate 132. Once the force is removed, mode clutch 124 becomes disengaged and ceases to transfer torque from rear output shaft 42 to front output shaft 32.

Additionally or alternatively, actuator 202 is selectively controllable to individually operate range clutch 72 by originally translating range sleeve 80. Accordingly, power transmission device 20 may be operated at a selected low, neutral, or high speed through use of range shift mechanism 74. Independent or concurrent mode shifting may be affected by controlling actuator 202 to engage or release mode clutch 124.

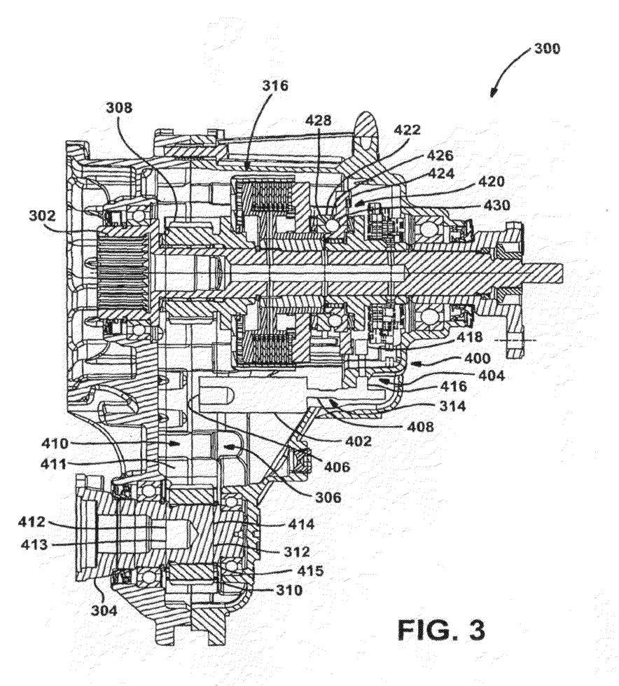

FIG. 3 illustrates a second embodiment power transmission device 300. Power transmission device 300 is substantially similar to power transmission device 20 except that power transmission device 300 is a single speed mechanism operable to selectively transfer drive torque from a first shaft 302 to a second shaft 304. Because power transmission device 300 is a single speed mechanism, an input shaft and a first output shaft are integrally formed as one-piece first shaft 302. First shaft 302 is adapted for connection to rear driveline 14 and second shaft 304 is adapted for connection to front driveline 12 (FIG. 1). A transfer assembly 306 is provided for selectively transferring drive torque from first shaft 302 to second shaft 304. Transfer assembly 306 includes a drive sprocket 308 rotatably supported on first shaft 302, a driven sprocket 310 fixed to second shaft 304, and a continuous flexible member 312, such as a power chain, drivingly connecting driven sprocket 310 to drive sprocket 308

To provide means for establishing a drive connection between first shaft 302 and second shaft 304, power transmission device 300 includes a mode shift mechanism 314. Mode shift mechanism 314 includes a mode clutch 316. Mode clutch 316 is operable to couple drive sprocket 308 to first shaft 302 for establishing a four-wheel drive mode wherein second shaft 304 is coupled for rotation with first shaft 302. In addition, mode clutch 316 is further operable to selectively release drive sprocket 308 from driven engagement with first shaft 302, thereby establishing a two-wheel drive mode in which all drive torque is delivered to first shaft 302.

FIG. 3 further depicts a clutch actuation system 400 that controls mode clutch 316. Clutch actuation system 400 includes an actuator 402 and may also include a rotary to linear movement conversion mechanism 404, In particular, actuator 402 includes a drive motor 406 for rotating a drive shaft 408. Drive motor 406 may be electrically or hydraulically powered. Actuator 402 need not be configured to include a drive motor but may utilize any number of suitable force transmitting mechanisms. Actuator 402 is shown to be at least partially located within a volume 410 bounded by an inner surface 411 of flexible member 312, a first plane 412 defined by a first edge 413 of flexible member 312, and a second plane 414 defined by a second edge 415 of flexible member 312.

Additionally, drive shaft 408 is coupled to rotary to linear movement conversion mechanism 404 to rotate a right angle gear drive 416. Right angle gear drive 416 rotates a pinion 418. Pinion 418 is drivingly coupled with a ball ramp unit 420. Ball ramp unit 420 includes a pair of cam rings 422 and 424 and a plurality of balls 426. Each of cam rings 422 and 424 include grooves 428 and 430, respectively. Grooves 428 and 430 have varying depths. Balls 426 are positioned within grooves 428 and 430. When balls 426 are positioned at the deepest portion of grooves 428 and 430, cam rings 422 and 424 are spaced apart a first distance from one another. Cam ring 424 is rotatable relative to cam ring 422 to cause balls 426 to be positioned within the shallow portion of grooves 428 and 430. At this position, cam rings 422 and 424 are spaced apart from one another a distance greater than the first distance. In this manner, ball ramp unit 420 is operable to convert rotary motion to linear motion.

In operation, actuator 402 is controlled to apply a clutch engagement force on mode clutch 316. Drive motor 406 rotates drive shaft 408 in a first direction which rotates right angle gear drive 416 in a first direction. Rotation of right angle gear drive 416 in a first direction causes pinion 418 to rotate in a first direction. Pinion 418 rotates cam ring 424 relative to cam ring 422 to axially move cam ring 422 and apply a clutch engagement force to mode clutch 316. Second shaft 304 is thereby drivingly coupled to first shaft 302. Rotating drive motor 406 in the reverse direction rotates cam ring 424 back to a start position thereby removing the clutch engagement force from mode clutch 316. Thus, second shaft 304 is no longer driven by first shaft 302.

The foregoing discussion discloses and describes various embodiments of the present disclosure. One skilled in the art will readily recognize from such discussion, and from the accompanying drawings and claims, that various changes, modifications and variations can be made therein without departing from the true spirit and fair scope of the disclosure as defined in the following claims.

What is claimed is:

1. A power transmission device for use in a vehicle having a power source and first and second drivelines, the power transmission device comprising:
an input shaft adapted to be driven by the power source;
a first output shaft adapted to transmit torque to the first driveline;
a second output shaft adapted to transmit torque to the second driveline;
a gearset driven by said input shaft and having an output member driven at a reduced speed relative to said input shaft;
a transfer unit having a first sprocket rotatably supported on one of said first and second output shafts, a second sprocket fixed for rotation with the other of said first and second output shafts, and a flexible member drivingly interconnecting said first sprocket and said second sprocket;
a first clutch operable in a first mode to selectively couple said first output shaft to said input shaft and in a second mode to selectively couple said output member of said gearset to said input shaft;
a second clutch selectively operable to transfer drive torque from said first output shaft to said second output shaft; and
a clutch actuation system operable to control said first and second clutches, said clutch actuation system including an actuator that is at least partially positioned within a volume defined by said flexible member.

2. The power transmission device of claim 1 wherein said second clutch is a friction plate clutch having a first set of friction elements fixed for rotation with said first output shaft and a second set of friction elements fixed for rotation with said first sprocket.

3. The power transmission device of claim 2 wherein said clutch actuation system includes a rotary to linear movement conversion mechanism.

4. The power transmission device of claim 3 wherein said clutch actuation system includes a drive motor and a rotatable drive shaft coupled to a right angle gear drive, said right angle gear drive having an output driving said rotary to linear movement conversion mechanism.

5. The power transmission device of claim 4 wherein said rotary to linear movement conversion mechanism includes a ball ramp unit, whereby a rotation of said right angle gear in a first direction causes a relative rotation between a pair of cam rings within said ball ramp unit for moving a first cam ring to an extended position and a rotation of said right angle gear in a second direction causes said cam rings to return to a start position.

6. The power transmission device of claim 2 wherein said rotary to linear movement conversion mechanism exerts a force on said first and second sets of friction elements.

7. The power transmission device of claim 1 wherein said drive shaft of said motor has an axis of rotation positioned parallel to axes of rotation of said first output shaft and said second output shaft.

8. The power transmission device of claim 1 wherein said actuator being extended completely through said volume circumscribed by said flexible member.

9. A power transmission device for use in a motor vehicle having a power source and first and second drivelines, the power transmission device comprising:
a first shaft adapted to be driven by the power source;
a second shaft adapted to transmit torque to the first driveline;
a transfer unit selectively operable to transmit drive torque between said first shaft and said second shaft, said transfer unit including a first sprocket rotatably supported on one of said first and second shafts, a second sprocket fixed for rotation with the other of said first and second shafts, and a flexible member drivingly interconnecting said first sprocket and said second sprocket;
a clutch selectively operable to drivingly interconnect said first sprocket and said one of said first and second shafts such that drive torque is transferred from said first shaft to said second shaft; and
a clutch actuation system operable to control actuation of said clutch, said clutch actuation system including an actuator that is at least partially positioned within a volume defined by said flexible member.

10. The power transmission device of claim 9 wherein said clutch is a friction disc clutch.

11. The power transmission device of claim 10 wherein said first shaft continuously transmits torque to said second driveline.

12. The power transmission device of claim 11 further including a gearset and a second clutch operable to drive one of said first and second drivelines at a reduced speed relative to one of said first and second shafts.

13. The power transmission device of claim 9 wherein said actuator includes a drive motor that is at least partially positioned within said volume defined by said flexible member.

14. The power transmission device of claim 9 including a clutch actuation system having an axial translatable member moveable between a first and a second position and a rotary to linear movement conversion mechanism interconnecting a rotatable output member of said actuator and said axial translatable member.

15. A power transmission device for use in a vehicle having a power source and first and second drivelines, the power transmission device comprising:
an input shaft adapted to be driven by the power source;
a first output shaft adapted to transmit torque to the first driveline;
a second output shaft adapted to transmit torque to the second driveline;
a gearset driven by said input shaft and having an output member driven at a reduced speed relative to said input shaft;
a transfer unit having a first sprocket rotatably supported on one of said first and second output shafts, a second sprocket fixed for rotation with the other of said first and second output shafts, and a flexible member drivingly interconnecting said first sprocket and said second sprocket;
a clutch operable in a first mode to selectively couple said first output shaft to said input shaft and in a second mode to selectively couple said output member of said gearset to said Input shaft; and
a clutch actuation system operable to control actuation of said clutch, said clutch actuation system including an actuator that is at least partially positioned within a volume defined by said flexible member.

16. A power transmission device for use in a motor vehicle, comprising:
a first shaft;
a second shaft;
a transfer assembly having a first sprocket rotatably supported on said first shaft, a second sprocket fixed to said second shaft, and a power chain encircling said first and second sprockets;
a clutch operable for coupling said first shaft to said second shaft, said clutch including a first clutch component fixed to said first shaft, a second clutch component fixed to said first sprocket, and a moveable clutch actuation member for selectively coupling said second clutch component for rotation with said first clutch component; and
a clutch actuator operable for moving said clutch actuation member, said clutch actuator including a power-operated device which is at least partially disposed in a space defined between said first and second sprockets and within said power chain.

17. The power transmission device of claim 16 wherein said power-operated device is an electric motor.
